(19) United States
(12) Patent Application Publication
(10) Pub. No.: US 2014/0142884 A1
(43) Pub. Date: May 22, 2014

(54) SYSTEM FOR MEASURING THERMAL CONDUCTANCE

(71) Applicant: KING FAHD UNIVERSITY OF PETROLEUM AND, Dhahran (SA)

(72) Inventors: AFTAB AHMAD, DHAHRAN (SA); LUAI M. HADHRAMI, DHAHRAN (SA)

(73) Assignee: KING FAHD UNIVERSITY OF PETROLEUM AND MINERALS, DHAHRAN (SA)

(21) Appl. No.: 13/681,327

(22) Filed: Nov. 19, 2012

(51) Int. Cl. G01K 17/06; G06F 15/00

(52) U.S. Cl. CPC G01K 17/06; G06F 15/00
USPC 702/136; 374/29

(57) ABSTRACT

The system for measuring thermal conductance includes first and second thermally insulated housing portions. A cooler is in communication with an interior of the first housing portion for selectively cooling the interior to a desired cool temperature. Similarly, a heater is in communication with an interior of the second housing portion for selectively heating the interior to a desired heated temperature. A test sample is retained within the second housing such that the test sample releasably and removably covers an aperture in communication with the interior of the first housing. Upon reaching thermal steady state, the temperatures T_{c} , T_{H} of cooled and heated surfaces of the test sample are both measured. A heat flux transducer, releasably mounted on the cooled surface of the test sample, measures heat flux q through the test sample. The thermal conductance U of the test sample may then be calculated as

$$U = \frac{q}{{T}_{H} - {T}_{C}} .$$

### BACKGROUND OF THE INVENTION

1. Field of the Invention

The present invention relates to measurement and testing of parameters relating to building materials, and particularly to a system for measuring the thermal conductance of a test sample.

2. Description Of The Related Art

Due to worldwide environmental issues, the use of thermally efficient building materials is of great importance. Particularly, in order to predict the use of both air conditioning and powered heating, the thermal conductance of building materials must be known. Although the measurement of thermal conductance is known, such testing is typically performed with laboratory equipment, such as guarded hot plates, heat flow meters, and guarded hot boxes, which are not suitable for large-scale and large-throughput testing of actual construction materials.

Further, the guarded hot plate and heat flow meter each require homogeneous samples to be tested for thermal performance. The samples to be tested are also required to be very thin, which, once again, is not suitable for testing of actual construction materials.

Thus, a system for measuring thermal conductance solving the aforementioned problems are desired.

### SUMMARY OF THE INVENTION

The system for measuring the thermal conductance relates to the measurement of thermal conductance, particularly of building or construction materials. The system includes a first housing portion formed from thermally insulated material and having an open end, and a second housing portion, also formed from thermally insulated material, having an aperture formed through a wall thereof, so that the wall removably and releasably seals the open end of the first housing. When joined together, the first and second housing portions form a box-shaped thermally insulated, fluid-tight test enclosure for measurement and testing, the apertured wall partitioning the enclosure into two thermally insulated chambers.

A cooler, such as a conventional refrigeration unit or the like, is in communication with the chamber defined by the first housing portion for selectively cooling the chamber to a desired cool temperature. Similarly, a heater, such as a conventional heating unit or the like, is in communication with the chamber defined by the second housing portion for selectively heating the chamber to a desired heated temperature.

The test sample is retained within the second housing portion such that the test sample releasably and removably covers the aperture formed in the partition wall. Upon reaching thermal steady state, the temperatures T_{C} , T_{H} , respectively, of the cooled surface of the test sample adjacent the open end of the first housing portion, and of the heated surface of the test sample opposite the cooled surface, are both measured. A heat flux transducer, releasably mounted on the cooled surface of the test sample, measures heat flux q through the test sample. The thermal conductance U of the test sample may then be calculated as:

$$U = \frac{q}{{T}_{H} - {T}_{C}} .$$

These and other features of the present invention will become readily apparent upon further review of the following specification and drawings.

### BRIEF DESCRIPTION OF THE DRAWINGS

FIG. 1 is a diagrammatic top plan view in section of a system for measuring thermal conductance according to the present invention.

FIG. 2 is a partially exploded diagrammatic side view in section of the test enclosure of the system of FIG. 1.

FIG. 3 is a perspective view of a test sample whose thermal conductance is to be measured by the system for measuring thermal conductance.

FIG. 4 is a block diagram illustrating components of a controller used in a system for measuring thermal conductance according to the present invention.

Similar reference characters denote corresponding features consistently throughout the attached drawings.

### DETAILED DESCRIPTION OF THE PREFERRED EMBODIMENTS

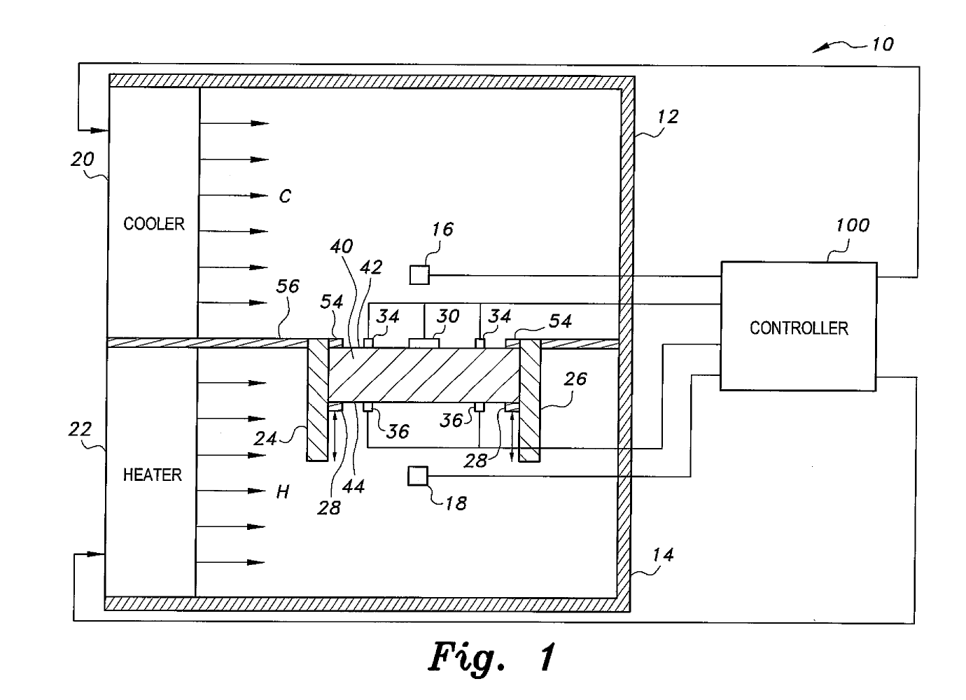

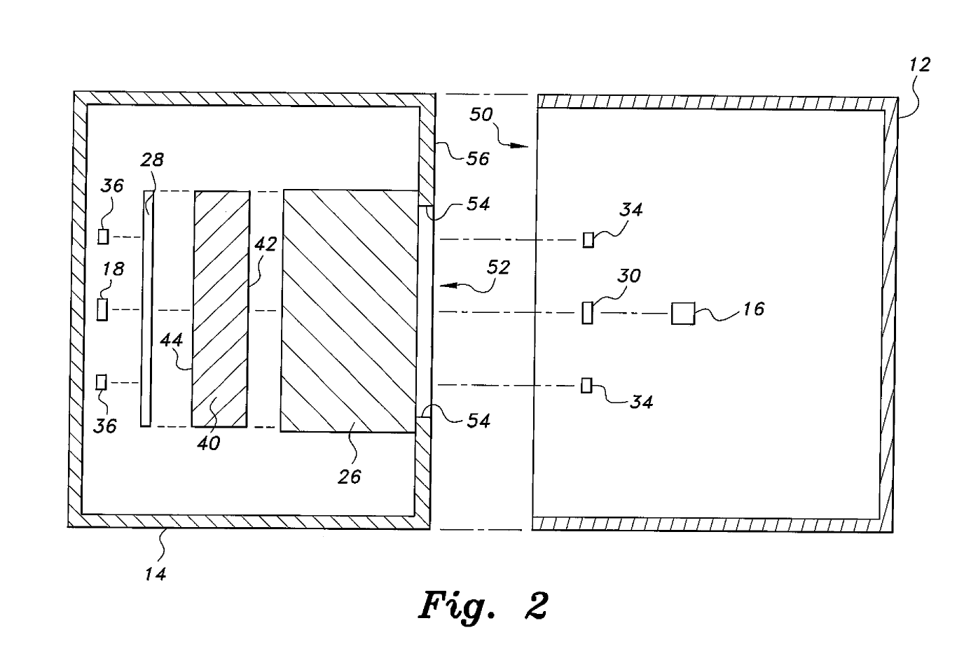

Referring to FIGS. 1 and 2, the system for measuring thermal conductance 10 includes a first housing portion 12 formed from thermally insulated material and having an open end 50, and a second housing portion 14, also formed from thermally insulated material, having an aperture 52 formed through a wall 56 thereof, such that the wall 56 removably and releasably seals the open end 50 of the first housing 12. When joined together, as in FIG. 1, the first and second housings 12, 14 form a box-shaped thermally insulated, fluid-tight test enclosure for measurement and testing, the apertured wall 56 partitioning the enclosure into a cooled chamber and a heated chamber.

A cooler 20, such as a conventional refrigeration unit or the like, is in communication with cooled chamber defined by the first housing portion 12 for selectively cooling the chamber to a desired temperature. Similarly, a heater 22, such as a conventional heating unit or the like, is in communication with the heated chamber defined by the second housing portion 14 for selectively heating the heated chamber to a desired temperature.

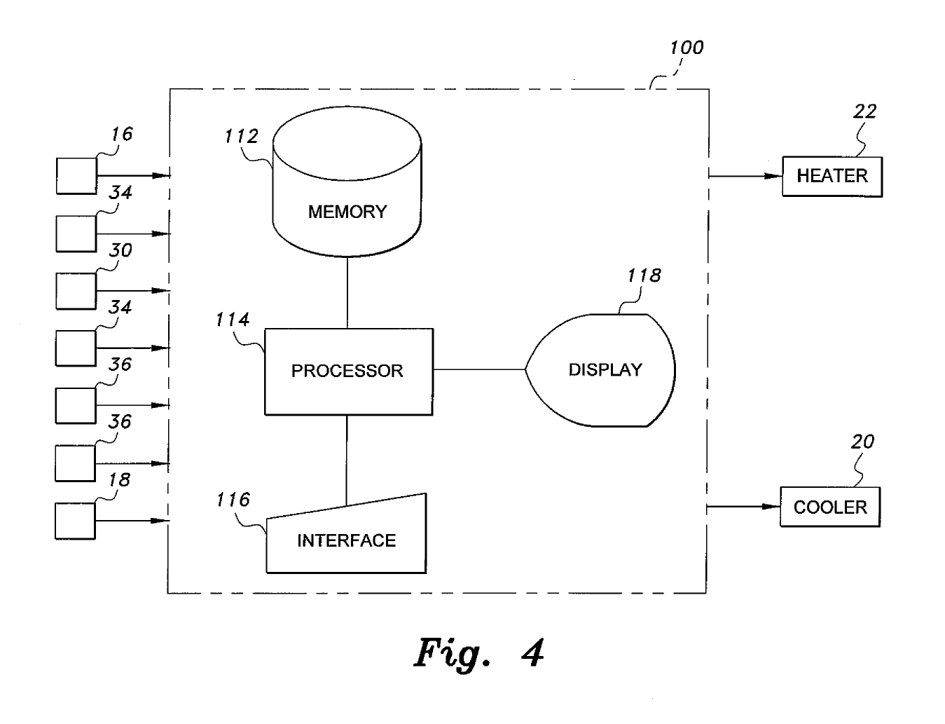

The ambient temperatures within the cooled chamber and the heated chamber are respectively measured by thermocouples 16, 18 or other temperature sensors. It should be understood that any suitable type of temperature measurement device or sensor may be utilized. As shown in FIGS. 1 and 4, the temperature measurements made by the thermocouples 16, 18 are transmitted to a controller 100. The controller 100, based upon the measured temperatures, adjusts the output of cooled air C generated by the cooler 20 and the output of heated air H generated by the heater 22 until the desired, pre-set temperatures are achieved.

Data is entered into the controller 100 via any suitable type of user interface 116, and may be stored in memory 112, which may be any suitable type of computer readable and programmable memory and is preferably a non-transitory, computer readable storage medium. Calculations are performed by a processor 114, which may be any suitable type of computer processor and may be displayed to the user on a display 118, which may be any suitable type of computer display.

The processor 114 may be associated with, or incorporated into, any suitable type of computing device, for example, a personal computer or a programmable logic controller. The display 118, the processor 114, the memory 112 and any associated computer readable recording media are in communication with one another by any suitable type of data bus, as is well known in the art.

Examples of computer-readable recording media include a magnetic recording apparatus, an optical disk, a magneto-optical disk, and/or a semiconductor memory (for example, RAM, ROM, etc.). Examples of magnetic recording apparatus that may be used in addition to memory 112, or in place of memory 112, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

The test sample 40 is retained within the second housing portion 14 such that the test sample 40 releasably and removably covers the aperture 52. As shown in FIGS. 1 and 2, first and second lateral retaining walls 24, 26 are mounted within the second housing portion 14 about the aperture 52, and extend into the heated chamber. The test sample 40 is slidably disposed therebetween. Further, a frame 28 is slidably disposed between the retaining walls 24, 26 for adjustably securing the test sample 40 adjacent the aperture. The frame 28 may be adjusted, with respect to the lateral retaining walls 24, 26, depending upon the thickness of test sample 40. Further, a retaining rim 54 is formed about the aperture 52 adjacent the open end 50 of the first housing portion 12, holding the test sample 40 such that it does not pass through the aperture 52 and into the cooling chamber.

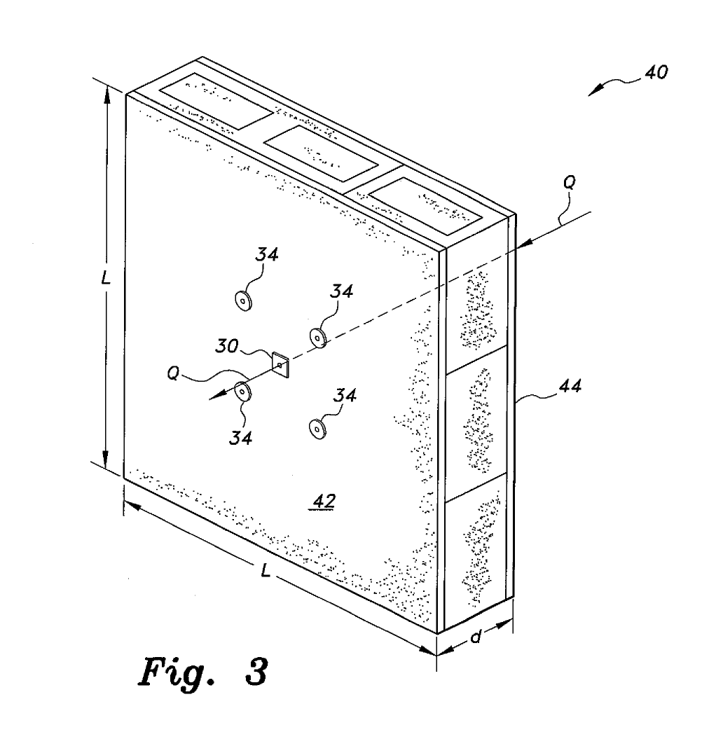

As shown in FIG. 3, the test sample 40, which may be a masonry wall test sample or a sample of any material for which thermal property measurement is desired, is preferably provided as a square slab, having side lengths L and a thickness d. It should, however, be understood that the test sample 40 may have any desired dimensions and configuration. The overall configuration of the retaining walls 24, 26, the frame 28, and the rim 54 may be adjusted to match the configuration of the test sample 40. Although the test sample 40 may have any desired dimensions, exemplary dimensions of length L may be on the order of approximately two feet in length.

One or more thermocouples 34 or the like are releasably secured to the cooled surface 42 of the test sample 40 for measuring the surface temperature T_{C} thereof. Similarly, one or more thermocouples 36 or the like are releasably secured to the heated surface 44 of test sample 40 for measuring the surface temperature T_{H} thereof. Upon reaching thermal steady state (i.e., when the heat flux and surface temperatures are constant over time), the steady-state temperature T_{C} of the cooled surface 42 of the test sample 40 adjacent the open end 50 of the first housing 12 and the steady-state temperature T_{H} of the heated surface 44 of the test sample 40 opposite the cooled surface 42 are both measured and recorded in memory 112. A heat flux transducer 30, which is releasably mounted on the cooled surface 42 of the test sample 40, measures heat flux q through the test sample. When the heat flux q also reaches steady state, the steady-state heat flux q is recorded in memory 112. The thermal conductance U of the test sample may then be calculated as

$$U = \frac{q}{{T}_{H} - {T}_{C}} .$$

As shown in FIG. 3, four thermocouples 34 are provided for measuring the temperature T_{C} of the cooled surface. This allows T_{C} to be the average temperature measured by the plurality of thermocouples 34, as calculated by the processor 114. It should be understood that any desired number of thermocouples 34 may be used. Similarly, any desired number of thermocouples 36 may be used for measuring T_{H}.

In addition to calculating the thermal conductance U, the equivalent thermal conductivity k_{eqv} of the test sample 40 may further be calculated as k_{eqv}=U×d, where d is the thickness of the test sample 40, as shown in FIG. 3. Additionally, the thermal resistance R of test sample 40 may be calculated as simply the inverse of the thermal conductance U, i.e.,

$$R = \frac{1}{U} .$$

The results of the calculations are preferably displayed to the user on the display 118.

It is to be understood that the present invention is not limited to the embodiments described above, but encompasses any and all embodiments within the scope of the following claims.

We claim:

1. A system for measuring thermal conductance, comprising:
a first box-shaped housing portion having an open end, the first housing portion being formed from thermally insulated material;
a second box-shaped housing portion having opposing end walls and an aperture defined in one of the end walls, the first housing portion being removably and releasably attachable to the second housing portion to define a thermally insulated test enclosure, the apertured end wall removably and releasably sealing the open end of the first housing portion and partitioning the enclosure so that the first housing portion defines a first chamber and the second housing portion defines a second chamber;
a cooler in communication with the first chamber for selectively cooling the first chamber;
a heater in communication with the second chamber for selectively heating the second chamber;
means for releasably retaining a test sample within the second chamber such that the test sample releasably and removably covers the aperture in the apertured end wall;
means for measuring temperature T_{C} of a cooled surface of the test sample on the cooled first chamber side of the aperture;
means for measuring temperature T_{H} of a heated surface of the test sample on an opposite heated surface of the test sample on the heated second chamber side of the aperture; and
a heat flux transducer mounted on the cooled surface of the test sample for measuring heat flux q through the test sample;
whereby thermal conductance U of the test sample is calculated by
$$U = \frac{q}{{T}_{H} - {T}_{C}} .$$

2. The system for measuring thermal conductance as recited in claim 1, further comprising means for measuring ambient temperature within the cooled first chamber.

3. The system for measuring thermal conductance as recited in claim 2, further comprising means for adjusting cooling output of said cooler based upon the measured ambient temperature of the cooled first chamber to regulate the temperature of the first chamber.

4. The system for measuring thermal conductance as recited in claim 3, further comprising means for measuring ambient temperature within the heated second chamber.

5. The system for measuring thermal conductance as recited in claim 4, further comprising means for adjusting heat output of said heater based upon the measured ambient temperature within the second chamber to regulate the temperature of the second chamber.

6. The system for measuring thermal conductance as recited in claim 5, wherein said means for measuring the ambient temperature within said first chamber comprises a first thermocouple.

7. The system for measuring thermal conductance as recited in claim 6, wherein said means for measuring the ambient temperature within said second chamber comprises a second thermocouple.

8. The system for measuring thermal conductance as recited in claim 1, wherein said means for releasably retaining the test sample comprises first and second retaining walls mounted laterally within said second chamber about the aperture, the test sample being adapted for sliding therebetween.

9. The system for measuring thermal conductance as recited in claim 8, wherein said means for releasably retaining the test sample further comprises a frame slidable between the first and second retaining walls for adjustably securing the test sample adjacent the aperture.

10. The system for measuring thermal conductance as recited in claim 9, further comprising a retaining rim formed about the aperture adjacent the open end of said first housing portion.

11. The system for measuring thermal conductance as recited in claim 1, wherein said means for measuring the temperature T_{C} comprises at least one first thermocouple releasably adapted for being secured to the cooled surface of the test sample.

12. The system for measuring thermal conductance as recited in claim 12, wherein said means for measuring the temperature T_{H} comprises at least one second thermocouple adapted for being releasably secured to the heated surface of the test sample.

13. A system for measuring thermal conductance, comprising:
a first box-shaped housing portion having an open end, the first housing portion being formed from a thermally insulated material;
a second housing a second box-shaped housing portion having opposing end walls and an aperture defined in one of the end walls, the first housing portion being removably and releasably attachable to the second housing portion to define a thermally insulated test enclosure, the apertured end wall removably and releasably sealing the open end of the first housing portion and partitioning the enclosure so that the first housing portion defines a first chamber and the second housing portion defines a second chamber;
to a cooler in communication with the first chamber for selectively cooling the first chamber;
a heater in communication with the second chamber for selectively heating second chamber;
means for releasably retaining a test sample within the second chamber such that the test sample releasably and removably covers the aperture;
means for measuring temperature T_{C} of a cooled surface of the test sample on the cooled first chamber side of the aperture;
means for measuring a temperature T_{H} of a heated surface of the test sample on an opposite heated surface of the test sample on the heated second chamber side of the aperture;
a heat flux transducer mounted on the cooled surface of the test sample for measuring heat flux q through the test sample;
a processor;
non-transitory computer readable memory coupled to the processor;
a display;
software stored in the computer readable memory and executable by the processor, the software having means for calculating a thermal conductance U of the test sample as
$$U = \frac{q}{{T}_{H} - {T}_{C}} ;$$
and
means for displaying the thermal conductance on the display.

14. The system for measuring thermal conductance as recited in claim 13, further comprising means for measuring ambient temperature within the first chamber.

15. The system for measuring thermal conductance as recited in claim 14, further comprising means for adjusting cooling output of said cooler based upon the measured ambient temperature of the cooled first chamber to regulate the temperature of the first chamber.

16. The system for measuring thermal conductance as recited in claim 15, further comprising means for measuring ambient temperature within the second chamber.

17. The system for measuring thermal conductance as recited in claim 16, further comprising means for adjusting heat output of said heater based upon the measured ambient temperature within the second chamber to regulate the temperature of the second chamber.

18. The system for measuring thermal conductance as recited in claim 5, wherein said means for measuring the ambient temperature within the first chamber and said means for measuring the ambient temperature within the second chamber each comprise a thermocouple.

19. The system for measuring thermal conductance as recited in claim 18, wherein said means for measuring the temperature T_{C} comprises at least one first thermocouple adapted for being releasably secured to the cooled surface of the test sample.

20. The system for measuring thermal conductance as recited in claim 19, wherein said means for measuring the temperature T_{H} comprises at least one second thermocouple adapted for being releasably secured to the heated surface of the test sample.
